(19) United States
(12) Patent Application Publication
(10) Pub. No.: US 2025/0100897 A1
(43) Pub. Date: Mar. 27, 2025

(54) METHOD FOR PREPARING NEODYMIUM CITRATE GELS

(71) Applicant: The Regents of the University of California, Oakland, CA (US)

(72) Inventors: Sarah Finkeldei, Irvine, CA (US); Jessica Granger-Jones, Irvine, CA (US)

(73) Assignee: The Regents of the University of California, Oakland, CA (US)

(21) Appl. No.: 18/896,209

(22) Filed: Sep. 25, 2024

Related U.S. Application Data
(60) Provisional application No. 63/540,180, filed on Sep. 25, 2023.

(51) Int. Cl. C01G 56/00; B33Y 70/00; C01F 17/10

(52) U.S. Cl. CPC C01G 56/009; C01F 17/10; B33Y 70/00; C01P 2004/32

(57) ABSTRACT

A method for forming a metal oxide includes a step of adding citrate acid to a salt-containing solution to produce a precursor solution. Characteristically, the salt-containing solution includes a neodymium salt or an americium salt. A chilled solution of hexamethylenetetramine (HMTA) and urea is added to a chilled precursor solution to form a citrate gel. Advantageously, citrate gel can be produced with an R-value of 0.5 to 3, wherein the R-value is a molar ratio of HMTA to Nd. The citrate gel is then heated to form the metal oxide of neodymium or americium.

### CROSS-REFERENCE TO RELATED APPLICATIONS

This application claims the benefit of U.S. provisional application Ser. No. 63/540,180 filed Sep. 25, 2023, the disclosure of which is hereby incorporated in its entirety by reference herein.

### TECHNICAL FIELD

In at least one aspect, the present invention is related to methods for making neodymium and americium-containing gels and microspheres and oxides therefrom.

### BACKGROUND

Neodymium oxide has gained attention for a wide variety of applications in various fields, including photonics, catalysis, and surface coatings. In addition, neodymium (III) is a common non-radioactive surrogate for actinides in the +3 state, namely americium (III). Americium oxides have various applications, such as in mixed oxide fuels for advanced fuel cycles and partitioning and transmutation efforts. Typically, Pu-238 has been used, but additional development of RPSs using other isotopes, such as Am-241 and Am-243, is desirable. When handling highly active minor actinides, such as americium, a dust-free synthesis technique is desired to reduce contamination, inhalation, and ingestion risks. Some of the conventional synthesis techniques including wet chemical approaches, used to fabricate neodymium oxides, such as precipitation and hydrothermal methods, are therefore undesirable for applications to americium as they tend to produce fine particulates. The primary sol-gel technique applied to neodymium involves the formation of alkoxides. However, difficulties in producing stable neodymium alkoxide polymers, as well as the tendency of an alkoxide sol-gel approach to produce fine powders make this synthesis route less desirable for applications to americium. A hexamethylenetetramine (HMTA)-urea based internal gelation route is typically used to fabricate metal oxide microspheres rather than powders and is thus a desirable technique to apply to the synthesis of americium oxide.

HMTA-urea internal gelation is a sol-gel synthesis technique wherein a chilled precursor containing a metal salt, urea as a complexing agent and HMTA as a gelation agent is heated to induce a series of reactions. The pertinent reactions upon heating are often considered to be: 1) decomplexation of the metal with urea, 2) hydrolysis of the metal, 3) protonation of HMTA, 4) decomposition of HMTA. The protonation and decomposition of HMTA raise the pH and result in the precipitation of the metal as a hydrous metal oxide gel. This process can be used to fabricate microspheres through the introduction of droplets of the chilled precursor into a heated organic medium (e.g., silicone oil or TCE). The organic medium is immiscible with the aqueous feed solution and serves to provide heat and structural support to the droplets so they solidify in the spherical shape of the droplets. Internal gelation offers many benefits over conventional synthesis techniques, including the ability to avoid dust formation, produce high-purity products, and tune the microstructure and properties of the spheres. While internal gelation can be applied to a wide variety of metals, it is limited to metals that hydrolyze and precipitate in the pH range attained in the process. HMTA is a buffer in the system, with a buffering range from around pH 4.1-6.1. This poses issues when applied to specific metals, including neodymium and americium, which are expected to hydrolyze and precipitate at higher pH values.

Accordingly, there is a need for improved methods for making neodymium and americium-containing gels and oxides therefrom.

### SUMMARY

In at least one aspect, the fabrication of neodymium oxide (e.g., Nd₂O₃) and of americium oxide (e.g., Am₂O₃) via the synthesis of citrate gels using the HMTA-urea internal gelation process is provided. It should be appreciated that the fabrication of Nd₂O₃ using neodymium citrate gels is a surrogate for producing americium oxide. Due to their similar ionic radii, chemical properties, and crystal phases, neodymium is a common non-radioactive surrogate for actinides in the +3 oxidation state, namely Am(III). Internal gelation is a highly desirable technique for synthesizing minor actinide compounds, as this process can synthesize minor actinide spheres with tunable properties while minimizing contamination risks (of particular importance for the highly active minor actinides). While internal gelation can be applied to various metals, Nd(III) has not been successfully gelled before using this process.

In another aspect, the spheres can be precursors for almost any shape of the final product. For example, the spheres can be maintained as spheres or pressed into shapes such as pellets.

In another aspect, the spheres can be used as 3D printing feedstock for any desirable shape.

In another aspect, a method for forming a metal oxide is provided. The method includes a step of adding citrate acid to a salt-containing solution to produce a precursor solution. Characteristically, the salt-containing precursor solution includes a neodymium salt or an americium salt. A chilled solution of hexamethylenetetramine (HMTA) and urea is added to ta chilled precursor solution to form a citrate gel. Advantageously, citrate gel can be formed from a composition having an R-value of 0.5 to 3, wherein the R-value is a molar ratio of HMTA to Nd. The citrate gel is then heated to form the metal oxide of neodymium or americium.

In another aspect, the method for forming a metal oxide is dust-free, thereby providing a relatively safe environment for processing and reacting radioactive elements such as americium.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic of a setup for forming metal oxide spheres.

FIG. 1B. Idealized schematic of a gelled citrate network.

FIG. 2. FTIR spectrum of a washed Nd-cit gel.

FIG. 3: Colormap indicating the influence of gelation temperature and R-value on the gelation time for gels fabricated with CA/Nd=1

FIG. 4. Influence of gelation temperature on gelation time for broths with R=1.6 and CA/Nd=1.

FIG. 5. Influence of R (HMTA/Nd) and CA/Nd on gelation time at 75° C.

FIG. 6 shows the PXRD pattern after sintering the Nd-citrate gel as described in Example 3. The reference for the crystallographic data is the Crystallographic Open Database: COD ID 2002849. The original publication of the CIF file used for comparison is: Mueller-Buschbaum, Hk. ‘On the Structure of the A-Form of the Sesquioxides of the Rare Earths.’ Zeitschrift für Anorganische und Allgemeine Chemie, 1966, 343, 6-10.

FIG. 7. SEM images of Nd₂O₃ microspheres sintered at 950° C. fabricated from neodymium citrate gels washed with a) acetone and PGME, and b) TCE and PGME.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including,” “comprising,” or “having.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions can be practiced with plus or minus 10 percent of the values indicated rounded to three significant figures of the value provided in the examples.

Throughout this application, where publications are referenced, the disclosures of these publications in their entireties are hereby incorporated by reference into this application to more fully describe the state of the art to which this invention pertains.

### Abbreviations

“cit” means citrate.
“HMTA” means hexamethylenetetramine.
“PGME” means propylene glycol methyl ether (1-methoxy-2-propanol).
“TCE” means trichloroethylene.

In at least one aspect, a method for forming a metal oxide is provided. The method includes a step of adding citrate acid to a salt-containing solution (i.e., an aqueous salt-containing solution) to produce a precursor solution. Characteristically, the salt-containing solution includes a neodymium salt or an americium salt. In a refinement, the neodymium salt or the americium salt are each independently a nitrate salt, citrate salt, a chloride salt, an acetate salt, or a carbonate salt. In a further refinement, the neodymium salt is neodymium nitrate, and the americium salt is americium nitrate. The method includes a step of chilling (e.g., temperature from 0 to 20° C.) the precursor solution to form a chilled precursor solution. A chilled solution of hexamethylenetetramine (HMTA) and urea is added to the chilled precursor solution to form a citrate gel. Advantageously, citrate gel (i.e., a hydrated metal citrate network) can be formed using an R-value of 0.5 to 3, wherein the R-value is a molar ratio of HMTA to Nd. In a refinement, the citrate gel can be formed using an R-value of 1.1 to 2.0. In some refinements, the citrate gel can be formed using an R-value of at least 0.5, 0.6, 0.7, 0.8, 0.9, or 1.0 and at most 4.0, 3.5, 3.0, 2.5, or 2.0. It should be noted that without citric acid, gelation is significantly prolonged.

In another aspect, the citrate gel is formed as citrate gel spheres. However, it should be appreciated that the citrate gel can be formed into virtually any three-dimensional shape.

In another aspect, the citrate gel spheres are heated to form spheres of metal oxide. In a refinement, the citrate gel is then heated to form the metal oxide of neodymium or americium. In one variation, the metal oxide is Nd₂O₃₋ₓ, where x is from −0.1 to 0.1. In a refinement, the metal oxide is Nd₂O₃. In another variation, the metal oxide is Am₂O_{3-y}, where y is from −0.1 to 0.1. In a refinement, the metal oxide is Am₂O₃. In another variation, the metal oxide is AmO_{2-z}, where y is from −0.1 to 0.1. In a refinement, the metal oxide is AmO₂.

In another aspect, the citrate gel forms at a temperature (i.e., the gelation temperature) from about 0 to 90° C. In a refinement, the citrate gel forms at a temperature from about 65° C. to 90° C. In another refinement, the citrate gel forms at a temperature of at least 0° C., 10° C., 20° C., 30° C., 40° C., 50° C., 60° C., or 65° C. and at most 90° C., 85° C., 80° C., 75° C., or 70° C.

In another aspect, the citrate gel is heated to a temperature greater than 550° C. to form the metal oxide. In some refinements, the citrate gel is heated to a temperature of at least 550° C., 600° C., 650° C., 700° C., 750° C., or 800° C. to form the metal oxide. In some further refinement, the citrate gel is heated to a temperature of at most 1100° C., 1000° C., 950° C., 900° C., 850° C., or 800° C. In still another refinement, the citrate gel is heated to a temperature from 600° C. to 1000° C.

In another aspect, a citric acid to neodymium molar ratio is from 0.5 to 1.5. In some refinements, the citric acid to neodymium molar ratio is at least 0.5, 0.6, 0.7, 0.8, 0.9, or 1.0 and at most 2.0, 1.8, 1.5, 1.4, 1.3, 1.2, or 1.1. In a refinement, the citric acid to neodymium molar ratio is from 0.7 to 1.

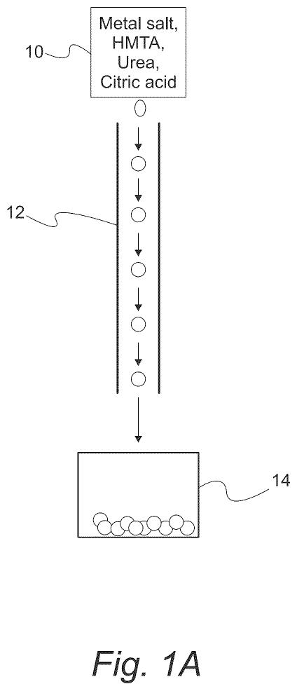

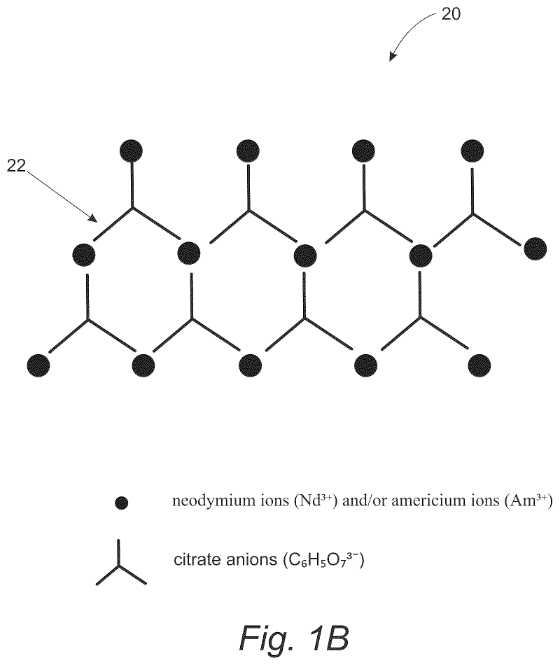

In another aspect, the citrate gel spheres are heated to form spheres of the metal oxide. In a refinement, the spheres are formed by heating the chilled solution of HMTA, urea, and the precursor solution in a heated immiscible liquid (e.g., silicone oil and/or TCE with a surfactant (a non-ionic surfactant such as Span80), referred to as a forming fluid, to form gelled neodymium citrate spheres. An example of a useful heated oil is a heated silicone oil. An example of another useful heated immiscible organic liquid is 4 vol % Span80 in TCE. In a refinement, the gelled neodymium citrate spheres can be reshaped and/or crystallized for use in subsequent processes. In particular, the gelled neodymium citrate spheres can be heated to form metal oxide spheres. The gelled neodymium citrate spheres can be from about 3 microns to 1000 microns or larger. FIG. 1 provides a schematic for forming gelled citrate spheres (e.g., gelled neodymium citrate spheres) in which a solution of a metal salt, hexamethylenetetramine (HMTA), urea, and citric acid 10 is dripped into column 12, which contains a heated oil. The spheres are collected in container 14. In a refinement, the gelled citrate spheres can also be formed in a microfluidic system.

With reference to FIG. 1B, a schematic of a gelled citrate object is provided. Gelled citrate object 20 includes a three-dimensional network 22 that includes neodymium ions (e.g., Nd³⁺) and/or americium ions (e.g., Am³⁺) linked by citrate ions. In a refinement, the three-dimensional network includes neodymium ions and/or americium ions in an amount greater than the amount of any other metal ion or dopant or combination thereof. It should be appreciated that the gelled objection can have a spherical shape or any other 3-dimensional shape. In a refinement, the gelled object has an average diameter from 3 microns to 2000 microns. As set forth above, gelled citrate object 20 can have a spherical shape. In a refinement, the three-dimensional network is a hydrated network.

In another aspect, the gelled citrate object further includes residues of hexamethylenetetramine and/or urea, which result from the methods disclosed herein.

In another aspect, the gelled citrate object is configured as a precursor for shaping into pellets or as feedstock for 3D printing. In a refinement, the gelled citrate object includes one or more additives selected from the group consisting of thinking agents, rheological modifiers (e.g., polyethylene glycol (PEG) or glycerol), crosslinking agents (e.g., calcium ions or other multivalent cations), and combinations thereof. Typically, the additive is present in a sufficient amount to set the viscosity into a predetermined range. In a further refinement, the viscosity is from about 5000 to 50000 cP at 25° C. or at the gelation temperature.

The following examples illustrate the various embodiments of the present invention. Those skilled in the art will recognize many variations that are within the spirit of the present invention and scope of the claims.

In this work, citric acid was added to the chilled neodymium nitrate solution as a precursor. This resulted in full gelation, producing a neodymium-citrate gel, which, upon heating, was converted to crystalline Nd₂O₃. The molar ratio of HMTA/Nd is defined as R-value. A chilled solution containing HMTA and urea was added to a chilled solution containing neodymium nitrate and citric acid. Gels were able to form with R-values as low as 0.5 and up to 3.0 as well as gelation temperatures as low as 0° C. and up to 90° C. The citric acid to neodymium mole ratio was varied from 0.5 to 1.5 and gels were able to be formed at all ratios evaluated. Subsequent heating was employed and successfully converted the gels to both cubic and trigonal phases of Nd₂O₃.

This work also demonstrated that droplets of the chilled precursor containing citric acid, neodymium nitrate, HMTA, and urea could be heated to result in the formation of neodymium citrate spheres, which could be subsequently heated to form neodymium oxide spheres.

This work also demonstrated that in the absence of citric acid, hydrous neodymium oxide gels can be formed using the internal gelation process over a prolonged period of time. Gels were formed at room temperature and at 75° C. for R-values ranging from 2.25 to 3.5.

For the first time, pure neodymium oxide was fabricated via the HMTA-urea internal gelation approach. Neodymium has not been gelled on its own before using internal gelation; in prior work using internal gelation, neodymium has only been incorporated as a dopant. Past work by X. Ding et al in Journal of Sol Gel Science and Technology, 90 (2019) pp. 296-304; used a citric acid precursor to produce cerium citrate gels using Ce(III). Our initial tests using neodymium nitrate, HMTA and urea indicated that Nd(III) behaves similarly to Ce(III) in the HMTA-urea internal gelation process. Thus, the typical internal gelation process was adapted for applicability to neodymium through the introduction of citric acid as a precursor to produce gels for later conversion into Nd₂O₃.

The composition of the broth and gelation temperature are of key importance to gel formation and gel properties. In the method of the present invention, an aqueous broth for the synthesis of neodymium citrate gels contains four chemical constituents: neodymium nitrate, citric acid, HMTA, and urea. Initially, two separate stock solutions are prepared. One contains neodymium nitrate and citric acid, and the other contains HMTA and urea. The neodymium nitrate acts as a source of neodymium for the production of the gel. The citric acid acts as a source of citrate anions to form a gel with the neodymium cations.

To prepare the broths, the precursor solutions are chilled to near 0° C. prior to mixing. The chilled precursors are combined with mixing and chilling. The broths are left to mix and chill until a clear broth forms. The broths are then heated to the desired temperature to produce neodymium citrate gels. The conditions listed in Table 1 were used to successfully produce neodymium citrate gels using this process.

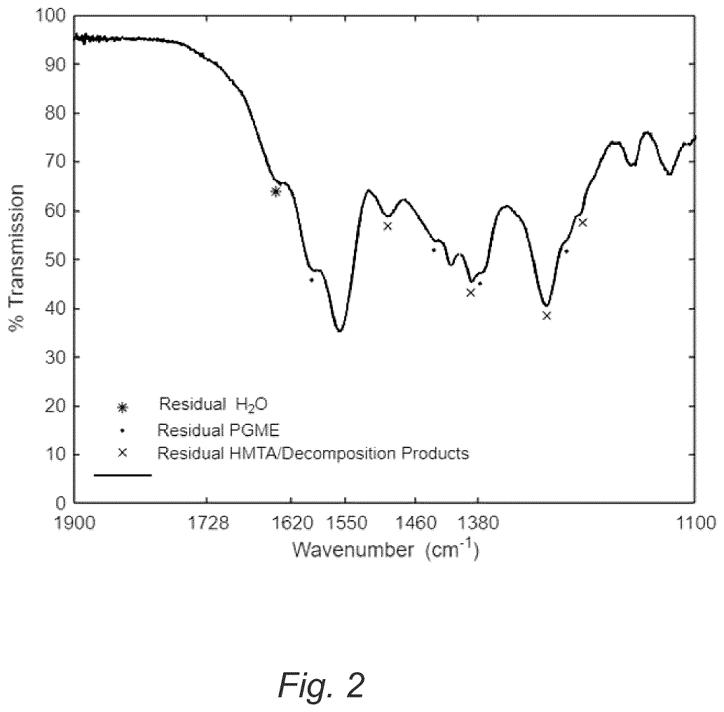

The gel forms [NdCit·xH₂O] rather than [Nd₂Hcit₃·xH₂O] as is evidenced by FTIR analysis. A representative FTIR spectrum is displayed in FIG. 2. While 2:3 lanthanide (III) citrates include citrates with both deprotonated and protonated carboxylic acid groups, in 1:1 lanthanide (III) citrates, all carboxylic acid groups are fully deprotonated. The FTIR spectra of the Nd-cit gel samples contain one peak corresponding to deprotonated carboxylic acid groups in the 1380-1460 cm⁻¹ range, one peak corresponding to deprotonated carboxylic acid groups in the 1550-1620 cm⁻¹ and no peak corresponding to a protonated carboxylic acid group at 1728 cm⁻¹, which is in agreement with [NdCit·xH₂O] formation. When the citric acid content is less than the neodymium content, it is suspected that the gel is comprised of [NdCit·xH₂O] and neodymium hydroxide because there is not enough citrate in the system to form [NdCit·xH₂O] complexes with all available neodymium.

TABLE 1
Gelation parameters used to produce neodymium citrate gels.

| Gelation | Citric | |
|---|---|---|
| Temperature | Acid/Nd³⁺ | HMTA/Nd³⁺ |
| (° C.) | (mol ratio) | (mol ratio) |
| 0 | 1 | 1.6 |
| | | 3.0 |
| 21 | 1 | 1.1 |
| | | 1.6 |
| 65 | 0.9 | 1.1 |
| | | 1.2 |
| | | 1.3 |
| | | 1.4 |
| | | 1.5 |
| | | 1.6 |
| | 1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| 70 | 1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| 75 | 0.5 | 1.6 |
| | 0.7 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| | 0.8 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| | 0.9 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| | 1 | 0.5 |
| | | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| | 1.1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| | 1.5 | 1.1 |
| 80 | 1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| 85 | 1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |
| 90 | 1 | 1.1 |
| | | 1.2 |
| | | 1.3 |
| | | 1.4 |
| | | 1.5 |
| | | 1.6 |
| | | 1.7 |
| | | 1.8 |
| | | 1.9 |
| | | 2.0 |

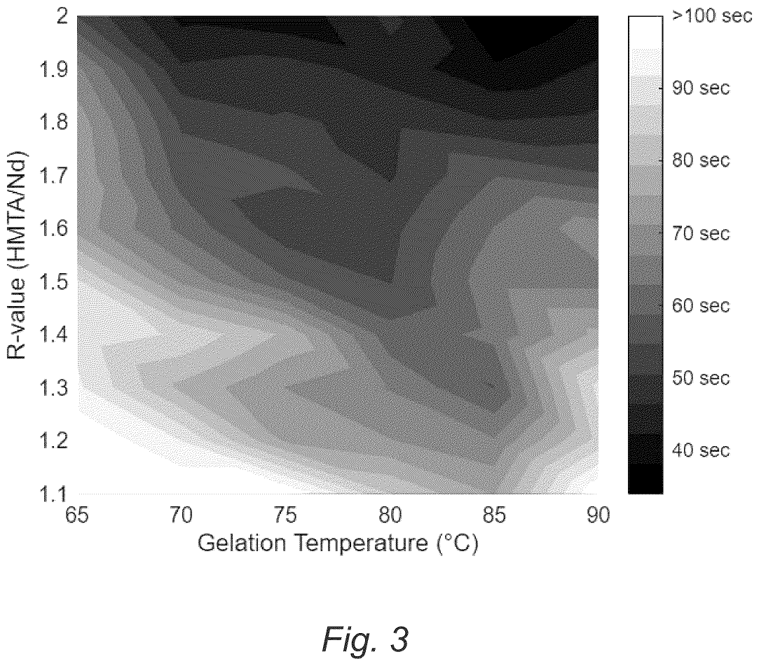

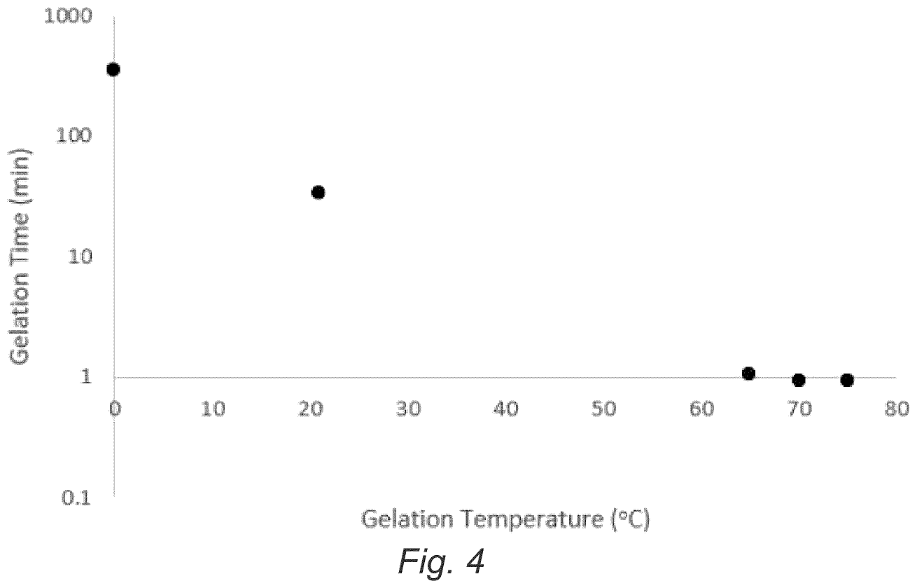

While successful gels were formed at temperatures as low as 0° C. and as high as 90° C., the temperature range of around 65° C.-90° C. was identified as a more optimal gel formation range. A colormap in FIG. 3 shows the gelation time dependence on R-value and temperature in these ranges. The gelation time tends to decrease with increasing temperature and increasing R-value. Gel hardness also tends to increase with increasing temperature and also appears to increase up to a certain R-value and then decrease. Temperatures below about 65° C. formed soft gels in a long timeframe (FIG. 4), which is not optimal.

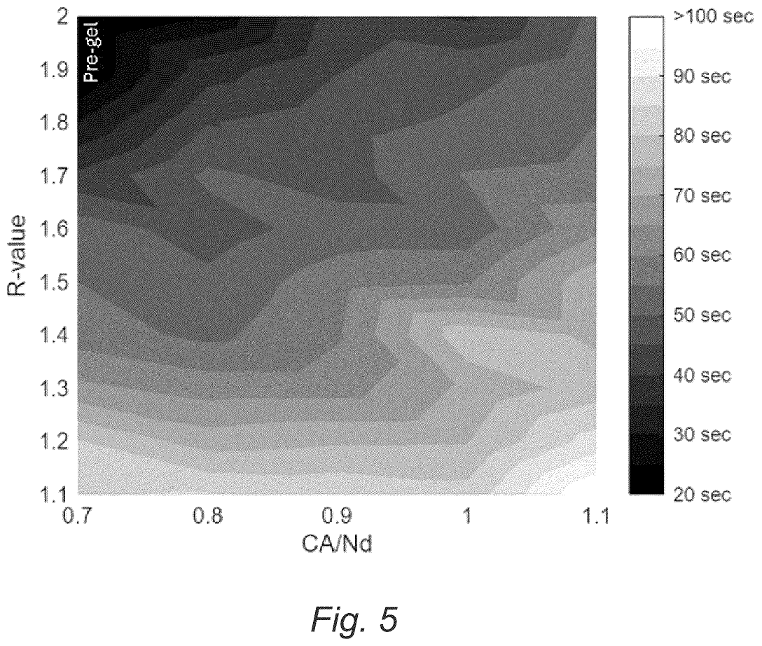

The citric acid to neodymium molar ratio (CA/Nd) was also varied from 0.5 to 1.5. The results for CA/Nd-0.7-1.1 are shown in FIG. 5. Broths with lower Ca/Nd tended to be more stable when chilled, but gelled more quickly upon heating, depicted in FIG. 5. Gels with CA/Nd>1 seemed to form less stable broths, as was evidenced by a tendency to pre-gel and to take longer to clear upon chilling and mixing. Gels with CA/Nd>1 also tended to take longer to fully gel upon heating (FIG. 5). Lower Ca/Nd ratios also tended to form harder gels, while gels with CA/Nd>1 tended to be softer.

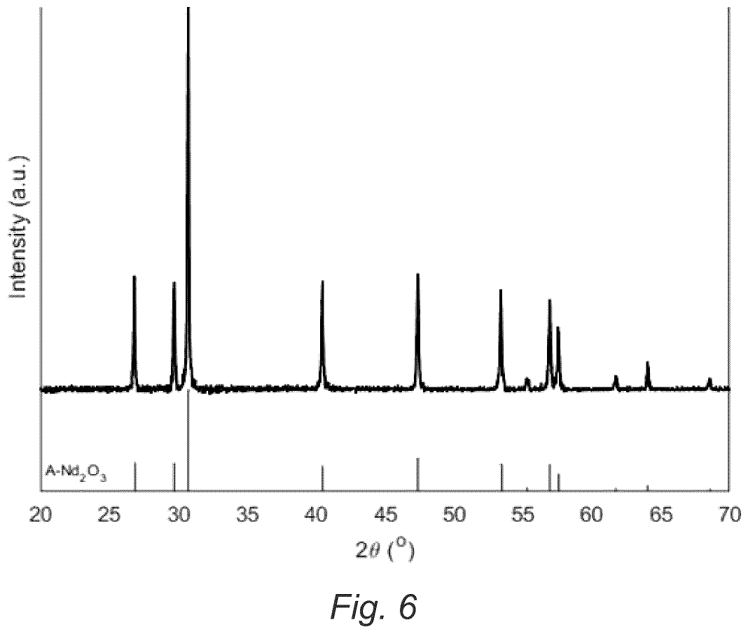

Upon sintering at 950° C., the neodymium citrate gel is converted to Nd₂O₃ in its high temperature trigonal phase. A representative XRD pattern of a neodymium citrate gel heated to 950° C. is displayed in FIG. 6; these results demonstrate that Nd₂O₃ can be fabricated via internal gelation using a citrate route. When the neodymium citrate gel was heated to 600° C. and 650° C., the resulting sample consisted of Nd₂O₃ in both the trigonal and cubic phases.

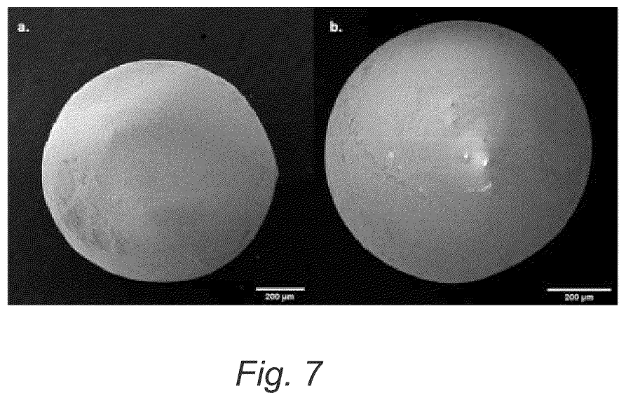

Microspheres were fabricated using the above formulations through introducing droplets of the chilled broth into heated silicone oil or heated TCE containing 4 vol % Span80. The gelled neodymium citrate spheres were left to age in the hot forming fluid, before being removed and washed with TCE or acetone to remove the silicone oil. Spheres were then washed with PGME and left to dry. The dried neodymium citrate spheres were subsequently calcined and sintered to produce crack-free neodymium oxide microspheres, as displayed in FIG. 7.

Gels were also prepared using a broth comprised of neodymium nitrate, HMTA, and urea. These gels were formed with R values ranging from 2.25 to 3.5. At room temperature, samples gelled over the course of several months. When heated to 75° C., samples with R values of 3.0 and 3.5 gelled, uncovered, within a few days.

### Procedures

### Example 1: Preparation of Sock Solutions

Stock solutions can be prepared using the following procedure. A stock solution containing 3.18 M HMTA and 3.18 M urea

(H-U) was prepared by dissolution of free flowing HMTA and urea in deionized water. A stock solution containing 2.3 M Nd(NO₃)₃ was prepared by dissolving neodymium nitrate hexahydrate in deionized water. A desired volume of the neodymium nitrate solution was added to a container (e.g., a test tube) and solid citric acid was added to this neodymium nitrate solution to reach the desired CA/Nd.

### Example 2: Gelation Tests

Gelation tests can be performed using the following procedure. Stock solutions were prepared as indicated in Example 1. The test tube with the neodymium nitrate-citric acid stock solution was placed in an ice bath to chill, and a stir bar is added. An excess of the H-U stock solution was added to a separate container e.g., scintillation vial or test tube and placed in the ice bath to cool. An aluminum block is heated to the desired gelation temperature. The stock solutions are chilled and the aluminum block is heated for a minimum of 30 minutes.

The test tube with the neodymium nitrate and citric acid is placed in an ice bath on a stir plate set to 550 rpm. The desired volume of chilled H-U stock solution is carefully added to the test tube. The broth is left to chill and stir for an additional 5 minutes.

The test tube is then transferred to the heated aluminum block on a stir plate set to 320 rpm. A stopwatch was used to measure the gelation time, defined as the time heating begins until the time the stir bar stops moving. The gel was then left in the heated aluminum block to age for an additional 10 minutes.

The test tube is then removed from the heated aluminum block and the gel is assessed for appearance, supernatant formation, and rigidity immediately after heating, after cooling to room temperature, and after approximately 24 hours.

### Example 3: Washing and Sintering

Neodymium citrate gels were converted to neodymium oxide through heating. Neodymium oxide can be prepared using the following procedure. Neodymium citrate gels were produced as outlined in Example 2. The gels were then washed with propylene glycol methyl ether (PGME) three times. Each wash step used 5 mL of PGME. The sample and wash liquid were agitated to a slurry and transferred to a centrifuge tube, and vortexed for two minutes. After each wash, the samples were centrifuged for 5 minutes at 4400 rpm, and the supernatant was disposed of prior to the next wash step. The samples were then dried for 2 hours in an oven set to 60° C. The samples were then heated to 600° C., 650° C. or 950° C. at a heating rate of 4.5° C./min and held at temperatures for 2 hours under airflow before cooling naturally to room temperature. It should be appreciated that airflow is not required to form the gels.

### Example 4: Microsphere Fabrication

Microspheres can be fabricated using the following procedure. Chilled broths were prepared as indicated in Example 2 and silicone oil and TCE/Span80 were heated on a hot plate to the desired gelation temperature. A syringe and needle were used to introduce droplets of the chilled broth into the hot silicone oil to induce gelation. The gelled spheres were then left in the hot silicone oil to age for 10 minutes. The spheres were separated from the oil. The spheres were then washed with trichloroethylene or acetone twice to remove residual silicone oil. The spheres were then washed three times with PGME. Spheres were then dried for 2 hours in an oven prior to calcining and sintering.

HMTA-urea internal gelation as a synthesis technique has benefits over other conventional synthesis techniques in its ability to form high purity products, require lower sintering temperatures, and facilitate the tuning of the product's structure and properties. When applied to neodymium, these benefits could be harnessed. When applied to americium (which is highly radioactive), one of the additional, crucial benefits is that internal gelation is a dust-free synthesis technique, which greatly increases safety as this reduces contamination risks, including inhalation and ingestion risks. Furthermore, the HMTA-urea internal gelation route does not face the difficulties in producing a stable gel when compared to the typically used alkoxide sol-gel synthesis route.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A gelled citrate object comprising:
a three-dimensional network including neodymium ions and/or americium ions linked by citrate ions.

2. The gelled citrate object of claim 1, wherein the object has an average diameter from 3 microns to 2000 microns.

3. The gelled citrate object of claim 1 having a spherical shape.

4. The gelled citrate object of claim 1, wherein the three-dimensional network is a hydrated network.

5. The gelled citrate object of claim 1, further comprising residues of hexamethylenetetramine and/or urea.

6. The gelled citrate object of claim 1, wherein the gelled citrate object is configured as a precursor for shaping into pellets or as feedstock for 3D printing.

7. The gelled citrate object of claim 6, further including additive selected from the group consisting of thinking agents, rheological modifiers, crosslinking agents, and combinations thereof, the additive being present in a sufficient amount to set viscosity of the gelled citrate object into a predetermined range.

8. A method for forming a metal oxide, the method comprising:
adding citrate acid to a metal salt-containing solution to produce a precursor solution, the metal salt-containing solution including a neodymium salt or an americium salt;
chilling the precursor solution to form a chilled precursor solution;
adding a chilled solution of hexamethylenetetramine (HMTA) and urea to the chilled precursor solution to form a citrate gel, wherein the citrate gel has an R-value of 0.5 to 3, wherein the R-value is a molar ratio of HMTA to Nd; and
heating the citrate gel to form the metal oxide of neodymium or americium.

9. The method of claim 8, wherein the citrate gel forms at a temperature from about 0 to 90° C.

10. The method of claim 8, wherein the citrate gel forms at a temperature from about 65° C. to 90° C.

11. The method of claim 8, wherein the citrate gel is heated to a temperature greater than 350° C. to form the metal oxide.

12. The method of claim 8, wherein the citrate gel is heated to a temperature from 600° C. to 1000° C.

13. The method of claim 8, wherein a citric acid to neodymium molar ratio is from 0.5 to 1.5.

14. The method of claim 8, wherein the metal oxide is Nd₂O₃.

15. The method of claim 8, wherein the metal oxide is Am₂O₃.

16. The method of claim 8, wherein the metal oxide is AmO₂.

17. The method of claim 8, wherein the metal oxide includes a combination of Am₂O₃ and AmO₂.

18. The method of claim 8, wherein the neodymium salt or the americium salt are each independently a nitrate salt, citrate salt, a chloride salt, an acetate salt or a carbonate salt.

19. The method of claim 8, wherein the neodymium salt is neodymium nitrate.

20. The method of claim 8, wherein the americium salt is americium nitrate.

21. The method of claim 8, wherein citrate gel is formed as citrate gel spheres.

22. The method of claim 21, wherein the citrate gel spheres are heated to form spheres of the metal oxide.

23. The method of claim 21, wherein gel microspheres are precursors to form any shape.

24. The method of claim 23, wherein gel microspheres are converted to pellets, or used as 3D printing feedstock for any desirable shape.

25. The method of claim 21, wherein the citrate gel spheres are formed by heating a chilled broth in an immiscible organic solvent with or without a surfactant.

26. The method of claim 25, wherein the immiscible organic solvent is a heated silicone oil.

27. The method of claim 25, wherein the immiscible organic solvent is TCE and the surfactant is Span80.
